(19) United States
(12) Patent Application Publication
(10) Pub. No.: US 2022/0024119 A1
(43) Pub. Date: Jan. 27, 2022

(54) APPARATUS, SYSTEM AND METHOD OF ADDITIVE MANUFACTURING TO IMPART SPECIFIED CHARACTERISTICS TO THE PRINT MATERIAL AND THE PRINTED OUTPUT

(71) Applicant: JABIL INC., St. Petersburg, FL (US)

(72) Inventors: Nicholas Dippel, St. Petersburg, FL (US); Luke Rodgers, St. Petersburg, FL (US)

(73) Assignee: JABIL INC., St. Petersburg, FL (US)

(21) Appl. No.: 17/311,676

(22) PCT Filed: Dec. 6, 2019
(86) PCT No.: PCT/US2019/065088

§ 371 Date: Jun. 7, 2021

Related U.S. Application Data
(60) Provisional application No. 62/776,332, filed on Dec. 6, 2018.

(51) Int. Cl. B29C 64/141; B29C 64/30

(52) U.S. Cl. CPC B29C 64/141; B33Y 40/00; B29C 64/30

(57) ABSTRACT

The disclosed exemplary apparatuses, systems and methods provide a three-dimensional molding, produced via a layer-by-layer process in which regions of respective layers of pulverant are selectively melted via introduction of electromagnetic energy. The embodiments comprise layers of the pulverant comprising at least thermoplastic polyurethane polymer (TPU) that provide a hardness of 40-100 Shore A; a tensile strength of 5 to 50 MPa; an elongation at break of 50 to 700%; a compression set of 5 to 60%; and a density of 0.9 to 1.8 g/cc.

### CROSS-REFERENCE TO RELATED APPLICATIONS

The present application claims benefit of priority to International Application No. PCT/US2019/065088, filed Dec. 6, 2019; entitled: “Apparatus, System and Method of Additive Manufacturing To Impart Specified Characteristics To The Print Material And The Printed Output,”, which claims the benefit of priority to U.S. Provisional Application No. 62/776,332, filed Dec. 6, 2018, entitled: “Apparatus, System and Method of Additive Manufacturing To Impart Specified Characteristics To The Print Material And The Printed Output,” the entirety of which is incorporated herein by reference as if set forth in its entirety.

### BACKGROUND

### Field of the Disclosure

The present disclosure relates to additive manufacturing, and, more specifically, to an apparatus, system and method of additive manufacturing to impart specified characteristics to the print material and the printed output.

### Description of the Background

Three-dimensional (3D) printing is any of various processes in which material is joined or solidified under computer control to create a three-dimensional object. The 3D print material is “added” onto a base, such as in the form of added liquid molecules or layers of powder grain or melted feed material, and upon successive fusion of the print material to the base, the 3D object is formed. 3D printing is thus a subset of additive manufacturing (AM).

A 3D printed object may be of almost any shape or geometry, and typically the computer control that oversees the creation of the 3D object executes from a digital data model or similar additive manufacturing file (AMF) file. Usually this AMF is executed on a layer-by-layer basis, and may include control of other hardware used to form the layers, such as lasers or heat sources.

There are many different technologies that are used to execute the AMF. Exemplary technologies may include, but are not limited to: fused deposition modeling (FDM); stereolithography (SLA); digital light processing (DLP); selective laser sintering (SLS); selective laser melting (SLM); inkjet print manufacturing (IPM); laminated object manufacturing (LOM); multijet fusion manufacturing (MJF); high speed sintering (HSS); and electronic beam melting (EBM).

Some of the foregoing methods melt or soften the print material to produce the print layers. For example, in FDM, the 3D object is produced by extruding small beads or streams of material which harden to form layers. A filament of thermoplastic, wire, or other material is fed into an extrusion nozzle head, which typically heats the material and turns the flow on and off.

Other methods, such as laser or similar beam-based techniques, may or may not heat the print material, such as a print powder, for the purpose of fusing the powder granules into layers. For example, such methods melt the powder using a high-energy laser to create fully dense materials that may have mechanical properties similar to those of conventional manufacturing methods. Alternatively, SLS, for example, uses a laser to solidify and bond grains of plastic, ceramic, glass, metal or other materials into layers to produce the 3D object. The laser traces the pattern of each layer slice into the bed of powder, the bed then lowers, and another layer is traced and bonded on top of the previous.

In contrast, other methods, such as IPM, may create the 3D object one layer at a time by spreading a layer of powder, and printing a binder in the cross-section of the 3D object. This binder may be printed using an inkjet-like process.

For most 3D printing needs, standard filaments are generally sufficient in terms of 3D product quality and workability. However, specific 3D product output needs may, at times, require an alternative print material. Historically, thermoplastic elastomers (TPE) have often been used to provide a 3D output object with specific, unique characteristics. However, the softness and other characteristics of TPE may make it difficult to work with and/or to provide additives to.

The prior art related to the foregoing AM print processes, including powder-based processes such as SLM and SLS, is limited to the use of a given powder print material corresponded to characteristics for a given part to be produced by the printing process. That is, each specialized part may have characteristics that dictate that a specialized print powder material be used to obtain the output part having the desired characteristics. This is the reason for the aforementioned use of TPE in discrete print circumstances, for example.

Accordingly, known print solutions, such as those that employ TPE, may focus on a particular material and its characteristics, a particular printing process and its characteristics, or, in rare circumstances, a final part and its characteristics. As such, the prior art does not provide a capability to focus on multiple characteristics of multiple aspects of the print process, such as characteristics of both the input material and the produced part, and is thus inflexible.

Therefore, the need exists for flexibility in the use of a powder print material that is suitable to be used in multiple print processes having different characteristics, and flexibility in the production therefrom of different specialized print parts having varying characteristics.

### SUMMARY

The disclosed exemplary apparatuses, systems and methods provide a three-dimensional molding, produced via a layer-by-layer process in which regions of respective layers of pulverant are selectively melted via introduction of electromagnetic energy, which, as used herein, includes any type of energy delivery methodology suitable to perform the disclosed manufacturing. The embodiments comprise layers of the pulverant comprising at least thermoplastic polyurethane polymer (TPU) that may provide, by way of example: a hardness of 30-100 Shore A; a tensile strength of 5 to 50 MPa; an elongation at break of 50 to 700%; a compression set of 5 to 60%; and a density of 0.9 to 1.8 g/cc, or less than 0.7 g/cc for a foam part. It should be understood that these ranges are provided by way of example only.

The molding may comprise one selected from the group consisting of sporting goods, medical devices, footwear, inflatable rafts, and outer cases for mobile devices. The process may comprise one of selective laser sintering (SLS) and selective laser melting (SLM).

The layers of the pulverant may further comprise one or more fillers. The one or more fillers may comprise at least one of glass beads, glass fibers, carbon fibers, carbon black, metal oxides, copper metals, flame retardants, antioxidants, pigments, and flow aids. The fillers and the TPU may form a foam layer via the layer-by layer process.

The disclosed exemplary apparatuses, systems and methods may also provide a pulverant suitable to provide a three-dimensional molding by use of the pulverant in a layer-by-layer additive manufacturing process in which regions of respective layers of pulverant are selectively melted via introduction of electromagnetic energy. The embodiments may comprise a thermoplastic polyurethane polymer (TPU) having a thermal processing window for the layer-by-layer additive manufacturing process in a range of, by way of example only, 20 to 55 degrees C.; a peak melting point in a range of 160 to 180 degrees C.; and a peak crystallization temperature of 95 to 115 degrees C.

Thus, the disclosed embodiments provide an apparatus, system, and method that are flexible in the use of a powder print material that is suitable to be used in multiple print processes having different characteristics, and flexibility in the production therefrom of different specialized print parts having varying characteristics.

### BRIEF DESCRIPTION OF THE DRAWINGS

The disclosed non-limiting embodiments are discussed in relation to the drawings appended hereto and forming part hereof, wherein like numerals indicate like elements, and in which:

FIG. 1 is an illustration of an additive manufacturing printing system;

FIG. 2 is a graphical illustration of a dynamic scanning calorimetry curve;

FIG. 3 illustrates an exemplary print material compound; and

FIG. 4 illustrates an exemplary computing system.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on”, “engaged to”, “connected to” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the embodiments.

The disclosed apparatus, system and method provide materials, and enable the production of additively manufactured parts from those materials, having properties presently unavailable in the known art. Further, embodiments include designs for specification that may match and/or correlate particular print materials, print material fillers, and printed output objects given one or more processes available to produce the printed output object.

More specifically, the embodiments provide additive manufacturing “print” materials that may consist of or include thermoplastic polyurethane (TPU) polymers, wherein the print materials exhibit properties that enable additive manufacturing of parts having previously unknown properties. The embodiments may provide these TPU-based print materials for any powder-centric (i.e., pulverant-based) additive manufacturing (AM) process, as discussed herein throughout, in to produce printed output parts from that AM process.

TPU is a print material that may deliver unique characteristics to an output object. TPU-based print materials may provide substantial improvements and advantages over known print materials for pulverant-based printing processes, including providing advantages over the TPE print materials referenced herein. By way of example, TPU-based print materials may provide a rubber-like elasticity, are resistant to abrasion, and perform well even at lower temperatures. For example, TPU-based print materials may be used to print output objects that bend or flex during application, such as sporting goods, medical devices, footwear, inflatable rafts, outer cases for mobile devices, and the like.

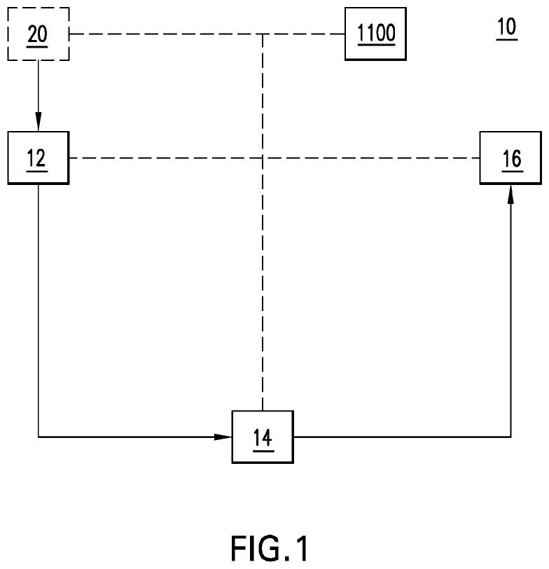

FIG. 1 illustrates a typical additive manufacturing (AM) system 10. In the illustration, a print material 12 is fed into a print process 14, such as the powder/pulverant-based AM processes discussed throughout, and the print process 14 outputs a printed 3D part 16. In the embodiments, the print material 12 may have the particular characteristics discussed herein, which may allow for the use of the print material 12 in any one or more processes 14, and which thereby result in any of various types of output parts 16 such as may have the characteristics discussed herein.

Additionally, computing system 1100 may execute one or more programs/algorithms 1190 to control one or more aspects of system 10, as referenced throughout. By way of example, program 1190 may be the AMF referenced herein above, and the AMF 1190 may independently control at least process 14. The AMF may additionally control the selection and/or distribution of print material 12, compounds 12a, and/or fillers, and may further modify processes 14, print materials 12, and so on in order to achieve a user-desired print output 16, as discussed further herein below.

More particularly, the embodiments include particular TPU-based print materials 12. These materials 12 may include a base TPU polymer, such as a polyether-based aromatic TPU by way of non-limiting example and may additionally include one or more additives or fillers 20, such as may further enhance the operating characteristics and operating windows discussed throughout the disclosure, and such as are discussed further herein below. A TPU polymer or other polymer may be mixed with an additive, filler, or low density particle, such as a microsphere, for example and may additionally include one or more additives, such as may further enhance the operating characteristics and operating windows discussed throughout the disclosure. Mixing may be accomplished by high shear blending, low shear blending, or a combination of high shear and low shear blending. The mixing process may be a dry mixing process to produce a dry blend.

To obtain a good dry blend, a combination of high shear and low shear mixing/blending can be used. A high shear mixer may be used to break up agglomerates and obtain a fluidized state of mixing resulting in a dry solid state. Care should be taken to avoid high temperatures. It is advantageous to form masterbatches or concentrates of additives with the powdered bulk resin. The concentrate or masterbatch is then blended, typically in a low shear blender, to disperse the additive and homogenize the blend.

In particular embodiments, the use of TPU-based polymer materials 12 may provide an enhanced thermal processing window, including enhanced crystallization and melt/melt enthalpy (J/g) ranges. By way of example, the enhanced thermal processing window may be in a range of 30, 35, or 40 degrees C. or more. That is, the input print material 12 processed in the embodiments may have a very wide operating window between the recrystallization temperature and the melting temperature.

By way of example with regard to this wide operating window, an initial material selection (e.g., ether/ester, aromatic/aliphatic) may be a first step. Other steps may include blending or compounding additives into a pellet, and/or other processes to improve processability both in grinding processes and in actual print processes.

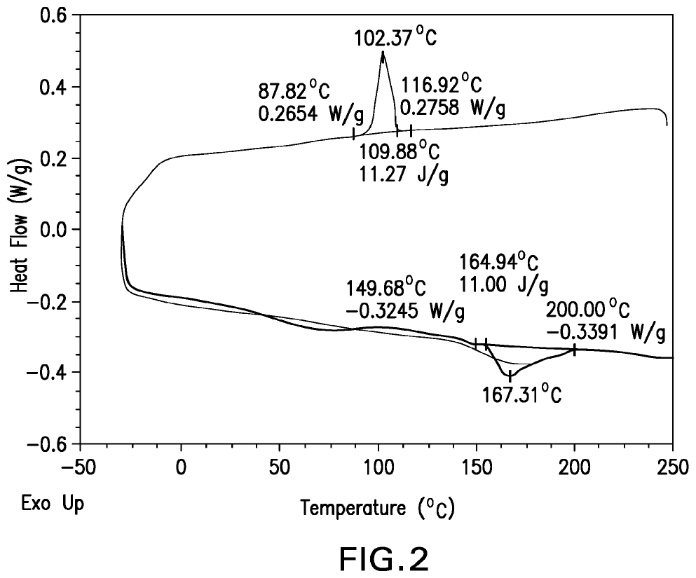

By way of example, the selected print material 12 may be a TPU polymer material 12 with a melting point (Tm) in the range 150° C. to 200° C., and with a peak Tm of 160 to 180 degrees C., such as at about 168° C., by way of example. The material 12 may provide a crystallization temperature (Tcryst) in the range 87° C. to 117° C., such as with a peak Tcryst in the range of 95 to 115 degrees C., such as at about 102° C., by way of example. The material 12 may have an operating window of 117° C. to 155° C., for example, which is indicative of a AT of 38° C. between Tm and Tcryst. FIG. 2 is a graphical illustration of Dynamic Scanning calorimetry (DSC) curve at 10 C/min for an exemplary TPU polymer material 12 suitable for use in printing process(es) 14 to produce the printed outputs 16 having the herein-indicated characteristics in the embodiments.

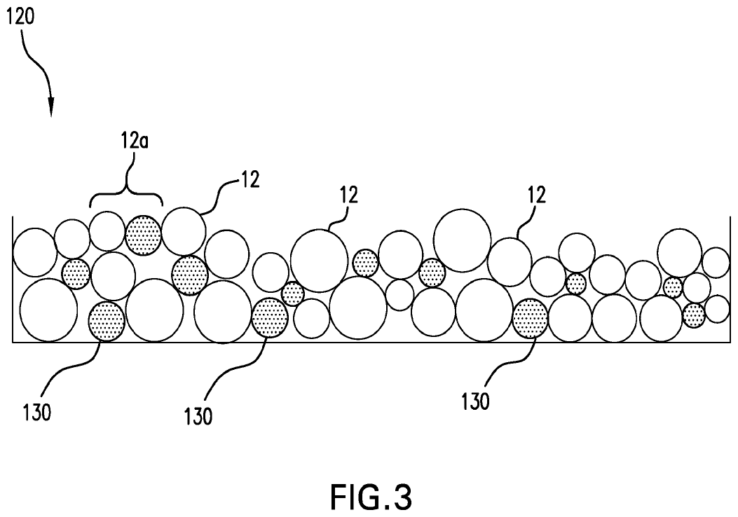

As will be understood by the skilled artisan, TPU print materials 12 that have greater sphericity may allow for tighter density of the AM print powder 120, as shown with greater particularity in FIG. 3, and hence provide less porosity and, thereby, improved inter- and intra-layer bonding upon exposure to process 14. By way of example, the AM print powder 120 in the embodiments may be comprised of near spherical particles of TPU print material 12, such as may have a sphericity of 0.4 to 1.0, by way of example, and which accordingly may provide a bulk density for powder 120 of 0.25 to 3.0 g/cc. Exemplary spherical particles have a distribution of 10 to 180 μm as measured using laser diffraction and reported in volume. More particularly a particle size distribution from 30 to 150 μm can be used.

As envisioned herein, these ranges may be achieved by using a specific grinding process, such as may employ cryogenic temperatures, pin mill design, classification, sieving, polishing steps, or ball milling, and/or by processing the material by spray drying, gas atomization, among other methods. The TPU print material 12 may be, for example, powdered into powder 120 using methods known in the current art.

As referenced, the disclosed print input TPU polymer materials 12 may be used in powder-based AM processes 14, such as those in which the AM powder 120 including the TPU polymer material 12 may be spread, melted in a targeted manner, and allowed to or processed to solidify, thus forming successive layers that result in a three-dimensional output object/part 16 having the characteristics discussed herein as indicative of both the process 14 and the input TPU polymer material 12. Processes 14 may include, but are not limited to: Selective Laser Sintering (SLS), Selective Laser Melting (SLM), Selective Heat Sintering (SHS), High Speed Sintering (HSS), Multi Jet Fusion (MJF), Binder Jetting (BJ), Material Jetting (MJ), Laminated Object Manufacturing (LOM), and other AM technologies referenced herein, and/or AM technologies that utilize thermoplastic powders/pulverants as may be known to the skilled artisan. It will also be understood to the skilled artisan that other AM and similar processes 14 may be modified to employ the TPU polymer materials 12 disclosed herein, including but not limited to injection molding, roto molding, vacuum molding, subtractive manufacturing, and so on.

As referenced above, and referring now again specifically to FIG. 3, fillers 130 may be included with TPU polymer material 12 in forming the AM powder 120. Fillers 130 may provide desired characteristics to AM powder 120, may enable or improve aspects of processes 14, or may provide desired characteristics to output part 16 produced by exposure of the input TPU polymer material 12 to process 14. Moreover, fillers 130 may enable the particular characteristics of input TPU polymer material 12 discussed with respect to FIG. 2, above, or may cause a modification to those characteristics, such as to provide the thermal processing window characteristics and associated characteristics illustrated graphically in FIG. 2. Fillers 130 may include, by way of non-limiting example, glass beads, glass fibers, carbon fibers, carbon black, metal oxides, copper metals, flame retardants, antioxidants, pigments, powder flow aids, and so on.

Of course, those skilled in the art will appreciate that prospective variations may occur in the manner in which fillers 130 are provided to TPU polymer material 12 to include in the AM powder 120. By way of example, the fillers 130 may be added to the TPU polymer materials 12 and mixed using known means, or may be coated by or onto the TPU material 12, such as by spray drying, paddle drying, belt drying, screen drying, conversion, High shear mixing, or use of a fluidized bed. The combination of TPU polymer materials 12 and fillers 130, such as by spray drying, may form compound particles 12a in powder 120, wherein the compound particles 12a may have properties of the outer TPU coating in accordance with the characteristics described herein, but also have characteristics indicative of inner-particles within the outer TPU-coating having different properties. The compound particles may thus, in turn, allow for variations in the properties of the output part 16.

In an exemplary embodiment, fillers 130 and TPU polymer materials 12 are mixed using a combination of high shear and low shear mixing/blending. To disperse particles in a dry solid state, the use of a high shear mixer is employed to break up agglomerates and obtain a fluidized state of mixing. Care should be taken to avoid high temperatures. It is advantageous to form masterbatches or concentrates of additives with the powdered bulk resin. The concentrate or masterbatch is then blended, typically in a low shear blender, to disperse the additive and homogenize the blend.

Additionally, a high shear mixer may be used to coat base particles with the coating. The high shear mixer may be heated. For example, the high shear mixer may be heated from 20° C. to 350° C. Coating and base particles may be added simultaneously to the high shear mixer before mixing. Alternatively, base particles may be first loaded into a high shear mixer and the high shear mixer may start to mix in the absence of coating. Coating may be added or sprayed into the high shear mixer to coat the previously loaded base particles. The high shear mixer may also function to dry a coating onto a base particle.

By way of example, a powder comprised of both fillers 130 and TPU polymer materials 12, that is, combined particles and/or compound 12a, may provide a lightweight, low density printed output part 16 with good rebound. Rather than avoiding porosity, as discussed above, the embodiment in this example may target higher levels of voids and porosity in the printed output 16, such that foam is produced having a desired density. This “TPU foam” output 16 may be used in a variety of applications, as it may produce a foam part that possesses gradient properties as desired throughout the single continuous part, while also providing the correct dimensions for the finished part in-process 14 as the gradient properties are imparted layer-by-layer.

For example, such a TPU foam may be employed in: footwear midsoles; footwear insoles; footwear outsoles; integral skin for vehicle interiors; bedding (mattress padding, solid-core mattress cores, general padding); upholstery foams; furniture (cushions, carpet cushion, structural foams); insulation foam (construction, wall/roof, window/door, air barrier sealants); packaging foam; simulated building materials; automotive exterior parts (facia); automotive and aerospace seating, interior trim, structural parts, electronics (potting compound); automotive seats, headrests, armrests, roof liners, dashboards and instrument panels; automotive steering wheels, bumpers/fenders; refrigeration/freezer insulation; moldings (construction and other); seals and gaskets; foam core doors, walls, panel; bushings; carpet underlay; parts for electronic instrumentation; surfboards; semi-rigid boat hulls; sporting goods (helmets, bike seats, padding, racquet grips, padding, filler in other rigid sporting goods); headsets; healthcare (physical therapy molds, custom braces, orthopedic cushions); pillows; sound proofing; and wheels (wheelchairs, bicycles, carts, toys).

For footwear parts produced by the printing methods referenced above, elastomeric compound input print materials 12, 120, 12a may be the most common. Examples of elastomeric compound print input materials 12 for footwear may include, by way of non-limiting example: styrene block copolymers; thermoplastic olefins; elastomeric alloys; thermoplastic polyurethanes; thermoplastic copolyesters; thermoplastic polyamides; ethylene-vinyl acetate; ethylene propylene rubber; ethylene propylene diene rubber; polyurethanes; silicones; polysulfides; and elastolefins.

As referenced, the TPU polymer material 12 provided to a process 14 may produce an output object 16 having particular desired characteristics, such as may be unique to a given operating circumstance for output 16. Such characteristics may include, but are not limited to: excellent hydrolysis resistance, high microbial resistance and bacteria resistance, high stability of melt, good colorability, and low-temperature flexibility, by way of non-limiting example.

Because the properties of the printed output part 16 may vary significantly based on the AM processes 14 applied to the TPU polymer material 12 as discussed throughout, approximate ranges of characteristics for the output part 16 are most appropriate. By way of example, the output part 16 may comprise a hardness of 30 to 100 Shore A; a tensile strength of 2 to 50 MPa; an elongation at break of 50 to 700%; a compression set (70 hours @ 23° C.) of 5 to 60%; and, for a foam part, a density less 0.9 g/cc.

Output products 16 provided from TPU polymer material 12 and being targeted to have the characteristics described herein and understood to the skilled artisan may relate to any of various industries and sectors. By way of non-limiting example, such industries and sectors may include industrial, consumer, automotive, aerospace, defense, medical, and the like.

As such, an output part 16 processed as described herein may provide correlated characteristics that are indicative of, and/or correlated to, the input TPU polymer material 12, as described herein throughout. Such characteristics may be measured, by way of non-limiting example, by heat-flowing a sample of the input 12 and/or the output 16, and then measuring thermal characteristics of the heat-flowed sample, such as Tm, Tg, Tcryst, heat of fusion, and the like. Likewise, infrared microscopy may allow for identification of the wavelengths of the corresponding chemical structures of the input material and/or the output object layers. Yet further, a thermogravimetric or similar analysis may be performed on a sample of the TPU polymer material 12 or printed TPU foam output 16, and this analysis may further include measurement of the composition of decomposition gases as the sample degrades, by way of example.

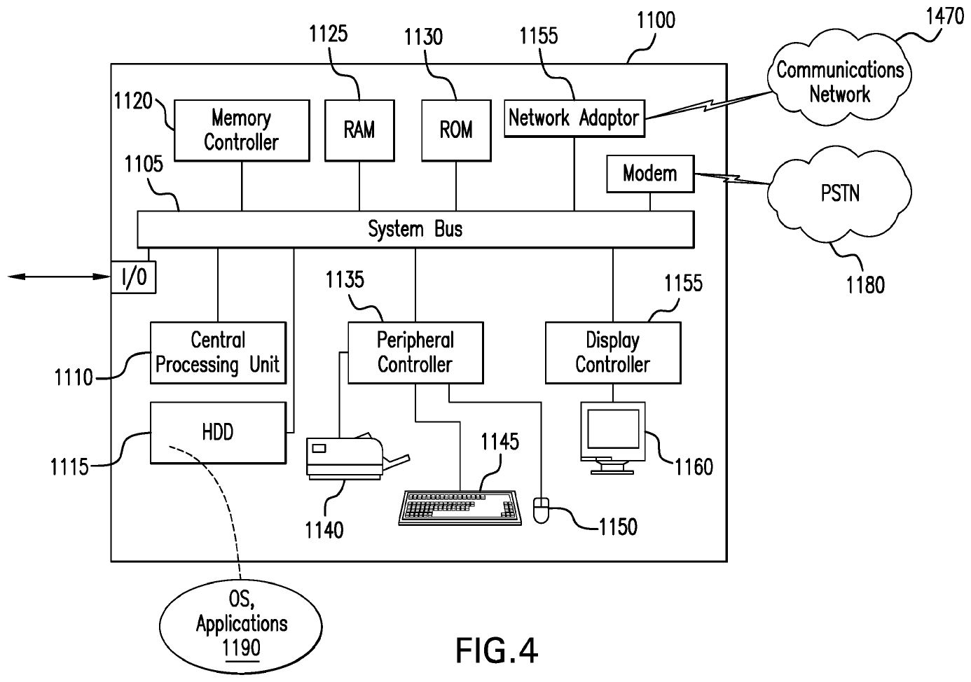

Of course, in view of the aforementioned prospective correlation of characteristics between an input TPU polymer material 12 and a printed output object 16, the correlated characteristics of output object 16 may vary dependently not only in accordance with the input TPU polymer material 12, but additionally based upon the process 14 employed to print the input TPU polymer material 12 into the output object 16. Accordingly, one or more computing programs/algorithms 1190, such as may comprise one or more AMF files; one or more input TPU polymer material 12, filler 120, and/or compound 12a choices, and/or one or more input material characteristic choices; one or more process choices and/or one or more process characteristics choices; and/or one or more output 16 shape, size, and or characteristic choices, may be executed by a computing system 1100. This execution may occur, for example, pursuant to an instruction to a GUI, such as to provide a particular correlation as between a TPU input material 12 and/or fillers 120 and a specific output object characteristic, and/or to use a particular available input TPU polymer material 12, using an available process 14, to target the ultimate production of a particular output TPU or TPU foam object 16. This is illustrated with particularity in FIG. 4.

More particularly, FIG. 4 depicts an exemplary computing system 1100 for use in association with the herein described systems and methods. Computing system 1100 is capable of executing software, such as an operating system (OS) and/or one or more computing applications/algorithms 1190, such as applications applying the correlation algorithms discussed herein, and may execute such applications 1190 using data, such as materials and process-related data, which may be stored 1115 locally or remotely.

That is, the application(s) 1190 may access, from a local or remote storage locations 1115, different TPU powders, fillers and compounds; powder-centric processes; and output object characteristics. The application 1190 may then allow a user, such as using a GUI, to select, for example, an input material, and, such as based on user selection of a process and/or process characteristics to which the input material was to be subjected, to provide the user with a variety of characteristics of the output object characteristics. Of course, likewise, a user may select desired output characteristics, and may be able to select one or more processes and/or process characteristics, and may be provided with an input material (including compound and/or fillers) that may be needed to obtain the desired selected output using the selected process.

More particularly, the operation of an exemplary computing system 1100 is controlled primarily by computer readable instructions, such as instructions stored in a computer readable storage medium, such as hard disk drive (HDD) 1115, optical disk (not shown) such as a CD or DVD, solid state drive (not shown) such as a USB “thumb drive,” or the like. Such instructions may be executed within central processing unit (CPU) 1110 to cause computing system 1100 to perform the operations discussed throughout. In many known computer servers, workstations, personal computers, and the like, CPU 1110 is implemented in an integrated circuit called a processor.

It is appreciated that, although exemplary computing system 1100 is shown to comprise a single CPU 1110, such description is merely illustrative, as computing system 1100 may comprise a plurality of CPUs 1110. Additionally, computing system 1100 may exploit the resources of remote CPUs (not shown), for example, through communications network 1170 or some other data communications means.

In operation, CPU 1110 fetches, decodes, and executes instructions from a computer readable storage medium, such as HDD 1115. Such instructions may be included in software, such as an operating system (OS), executable programs such as the aforementioned correlation applications, and the like. Information, such as computer instructions and other computer readable data, is transferred between components of computing system 1100 via the system's main data-transfer path. The main data-transfer path may use a system bus architecture 1105, although other computer architectures (not shown) can be used, such as architectures using serializers and deserializers and crossbar switches to communicate data between devices over serial communication paths. System bus 1105 may include data lines for sending data, address lines for sending addresses, and control lines for sending interrupts and for operating the system bus. Some busses provide bus arbitration that regulates access to the bus by extension cards, controllers, and CPU 1110.

Memory devices coupled to system bus 1105 may include random access memory (RAM) 1125 and/or read only memory (ROM) 1130. Such memories include circuitry that allows information to be stored and retrieved. ROMs 1130 generally contain stored data that cannot be modified. Data stored in RAM 1125 can be read or changed by CPU 1110 or other hardware devices. Access to RAM 1125 and/or ROM 1130 may be controlled by memory controller 1120. Memory controller 1120 may provide an address translation function that translates virtual addresses into physical addresses as instructions are executed. Memory controller 1120 may also provide a memory protection function that isolates processes within the system and isolates system processes from user processes. Thus, a program running in user mode may normally access only memory mapped by its own process virtual address space; in such instances, the program cannot access memory within another process' virtual address space unless memory sharing between the processes has been set up.

In addition, computing system 1100 may contain peripheral communications bus 1135, which is responsible for communicating instructions from CPU 1110 to, and/or receiving data from, peripherals, such as peripherals 1140, 1145, and 1150, which may include printers, keyboards, and/or the sensors discussed herein throughout. An example of a peripheral bus is the Peripheral Component Interconnect (PCI) bus.

Display 1160, which is controlled by display controller 1155, may be used to display visual output and/or other presentations generated by or at the request of computing system 1100, such as in the form of a GUI, responsive to operation of the aforementioned computing program(s). Such visual output may include text, graphics, animated graphics, and/or video, for example. Display 1160 may be implemented with a CRT-based video display, an LCD or LED-based display, a gas plasma-based flat-panel display, a touch-panel display, or the like. Display controller 1155 includes electronic components required to generate a video signal that is sent to display 1160.

Further, computing system 1100 may contain network adapter 1165 which may be used to couple computing system 1100 to external communication network 1170, which may include or provide access to the Internet, an intranet, an extranet, or the like. Communications network 1170 may provide user access for computing system 1100 with means of communicating and transferring software and information electronically. Additionally, communications network 1170 may provide for distributed processing, which involves several computers and the sharing of workloads or cooperative efforts in performing a task. It is appreciated that the network connections shown are exemplary and other means of establishing communications links between computing system 1100 and remote users may be used.

Network adaptor 1165 may communicate to and from network 1170 using any available wired or wireless technologies. Such technologies may include, by way of non-limiting example, cellular, Wi-Fi, Bluetooth, infrared, or the like.

It is appreciated that exemplary computing system 1100 is merely illustrative of a computing environment in which the herein described systems and methods may operate, and does not limit the implementation of the herein described systems and methods in computing environments having differing components and configurations. That is to say, the inventive concepts described herein may be implemented in various computing environments using various components and configurations.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. A three-dimensional molding, produced via a layer-by-layer process in which regions of respective layers of pulverant are selectively melted via introduction of electromagnetic energy, comprising:
the layers of the pulverant comprising at least thermoplastic polyurethane polymer (TPU) that provide a hardness of 40-100 Shore A; a tensile strength of 5 to 50 MPa; an elongation at break of 2 to 700%; a compression set of 5 to 90%; and a density of 0.25 to 3.0 g/cc.

2. The molding of claim 1, wherein the molding comprises one selected from the group consisting of sporting goods, medical devices, footwear, inflatable rafts, and outer cases for mobile devices.

3. The molding of claim 1, wherein the electromagnetic energy comprises one of selective laser sintering (SLS), high speed sintering (HSS) and Multijet Fusion (MJF).

4. The molding of claim 1, the layers of the pulverant further comprising one or more fillers.

5. The molding of claim 4, wherein the one or more fillers comprise at least one of glass beads, glass fibers, carbon fibers, carbon black, metal oxides, copper metals, flame retardants, antioxidants, pigments, and flow aids.

6. The molding of claim 4, wherein the fillers are mixed into the TPU to form the pulverant.

7. The molding of claim 4, wherein the fillers are coated onto or by the TPU material to form the pulverant.

8. The molding of claim 7, wherein the coating is produced by one of spray drying, paddle drying, belt drying, screen drying, conversion, and a fluidized bed.

9. The molding of claim 4, wherein the fillers and the TPU form a foam layer via the layer-by layer process.

10. A pulverant suitable to provide a three-dimensional molding by use of the pulverant in a layer-by-layer additive manufacturing process in which regions of respective layers of pulverant are selectively melted via introduction of electromagnetic energy, comprising:
a thermoplastic polyurethane polymer (TPU) having a thermal processing window for the layer-by-layer additive manufacturing process in a given temperature range; a peak melting point in a range of 165 to 175 degrees C.; and a peak crystallization temperature of 102 to 105.

11. The pulverant of claim 10, wherein the TPU comprises a melting point in a range of 150° C. to 200° C.

12. The pulverant of claim 10, wherein the TPU comprises a crystallization temperature in a range of 87° C. to 117° C.

13. The pulverant of claim 10, wherein the TPU comprises a thermal operating window of about 117° C. to 155° C.

14. The pulverant of claim 10, wherein the TPU comprises a sphericity of 0.5 to 0.9.

15. The pulverant of claim 10, wherein the pulverant comprises a bulk density of 0.2 to 1.3 g/cc.

16. The pulverant of claim 10, wherein the layer-by-layer additive manufacturing process comprises one of selective laser sintering (SLS) and selective laser melting (SLM).

17. The pulverant of claim 10, further comprising one or more fillers.

18. The pulverant of claim 17, wherein the fillers are mixed into the TPU to form the pulverant.

19. The pulverant of claim 17, wherein the fillers are coated onto or by the TPU material to form the pulverant.

20. The pulverant of claim 17, wherein the fillers and the TPU form a foam layer via the layer-by layer process.
